(19) United States
(12) Patent Application Publication
(10) Pub. No.: US 2026/0227932 A1
(43) Pub. Date: Aug. 6, 2026

(54) STORING DATA TO HOST SYSTEM MEMORY UPON ENTRY OF A MEMORY SYSTEM NON-OPERATIONAL POWER STATE

(71) Applicant: Micron Technology, Inc., Boise, ID (US)

(72) Inventors: Gaurav SINHA, Oberschleißheim (DE); Nicholas T. HEATH, Pittsboro, NC (US)

(21) Appl. No.: 19/442,746

(22) Filed: Jan. 7, 2026

Related U.S. Application Data
(60) Provisional application No. 63/754,929, filed on Feb. 6, 2025.

(51) Int. Cl. G06F 3/06

(52) U.S. Cl. CPC G06F 3/0656; G06F 3/0623; G06F 3/0659; G06F 3/0679

(57) ABSTRACT

Various aspects of the present disclosure generally relate to wireless communication. In some aspects, a memory system may allocate a portion of a host system volatile memory as a buffer for storing data associated with the memory system when the memory system is in a non-operational power state. The memory system may determine a set of data stored in a memory system volatile memory that is to be preserved when the memory system is in the non-operational power state. The memory system may write the set of data to the buffer prior to entering the non-operational power state. Numerous other aspects are described.

### CROSS REFERENCE TO RELATED APPLICATION

This Patent Application claims priority to U.S. Provisional Patent Application No. 63/754,929, filed on February 6, 2025, and entitled “STORING DATA TO HOST SYSTEM MEMORY UPON ENTRY OF A MEMORY SYSTEM NON-OPERATIONAL POWER STATE.” The disclosure of the prior Application is considered part of and is incorporated by reference into this Patent Application.

### TECHNICAL FIELD

The present disclosure generally relates to memory devices, memory device operations, and, for example, to storing data to host system memory upon entry of a memory system non-operational power state.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of storing data to host system memory upon entry of a memory system non-operational power state.

FIG. 2 is a diagram of another example system capable of storing data to host system memory upon entry of a memory system non-operational power state.

FIG. 3 is a diagram of an example process associated with a memory system entering a non-operational power state.

FIG. 4 is a diagram of an example process associated with a memory system exiting a non-operational power state.

FIG. 5 is a flowchart of an example method associated with storing data to host system memory upon entry of a memory system non-operational power state.

### DETAILED DESCRIPTION

In the realm of nonvolatile memory (NVM) technologies, such as managed NAND devices and solid-state drives (SSDs), among other technologies, energy efficiency is important for certain power-sensitive applications, such as electric vehicles, mobile phones, and other portable electronics. A push for increased energy efficiency for certain devices has led to the adoption of power-saving measures, such as by the device entering non-operational power states (e.g., power state 3 (PS3) and/or power state 4 (PS4)) associated with peripheral component interconnect express (PCIe) nonvolatile memory express (NVMe) SSDs, which aim to minimize power consumption when the SSD is idle. These power states are achieved by deactivating internal power domains within the SSD, thereby conserving energy while allowing for quick resumption of full power operation when the SSD is to be returned to an operational mode.

However, this approach to energy conservation introduces challenges related to NVM reliability and endurance. For example, when SSD subsystems or components are powered down to transition into low power states, the SSD’s context must be preserved to avoid the need for full reinitialization upon the non-operational power state exit. This preservation typically involves saving a substantial amount of context data from the SSD’s volatile memory (e.g., SRAM) to the SSD’s nonvolatile NAND memory. The frequent transitioning into and out of these power states, driven by aggressive operating system settings, may lead to a non-trivial amount of data being written to the NAND over the life of the SSD. This data writing, although instrumental for power saving, contributes significantly to wear on the SSD, as NAND memory has limited endurance in terms of write cycles. For instance, a transition to a PS3 state might require writing of approximately 200 kilobytes (KB) of context data to NAND memory, and with potentially millions of transitions over an SSD’s lifetime, the total amount of data written can be substantial. For example, for an SSD with an endurance range of 100-200 terabytes (TB), 6 TB of data may be written over the SSD’s life to support power state transitions.

Some implementations described herein enable techniques for reducing SSD wear by utilizing a portion of a host system’s volatile memory as buffer storage when the SSD transitions to a non-operational power state. The techniques described herein include determining a set of data stored in the SSD’s volatile memory that is to be preserved during the non-operational power state and writing this data to a buffer in the host system’s volatile memory before the SSD enters the non-operational power state. In some aspects, the data is written to the buffer using a PCIe memory write operation, and this process may thus be executed using a PCIe interface component associated with the SSD.

In this way, the method mitigates the number of write cycles to the SSD’s NAND memory during transitions into and out of low power states, which otherwise may significantly contribute to SSD wear. The reduction in write cycles to the NAND memory may enhance the SSD’s operational lifespan and reliability. Additionally, or alternatively, the techniques described herein enable a decrease in wear-leveling and garbage collection activities, which in turn conserves processing resources within the SSD’s controller. Furthermore, by leveraging the host system’s volatile memory, the techniques described herein may achieve faster entry and exit times from power-saving states due to the reduced latency of volatile memory (e.g., DRAM) compared to NVM (e.g., NAND memory). This efficiency in power state management provides a sustainable method to extend the life of the SSD while maintaining the performance characteristics required for power-sensitive applications. In this way, the solution may conserve processing resources, memory resources, network resources, and/or the like, offering a technically advanced and resource-efficient storage solution.

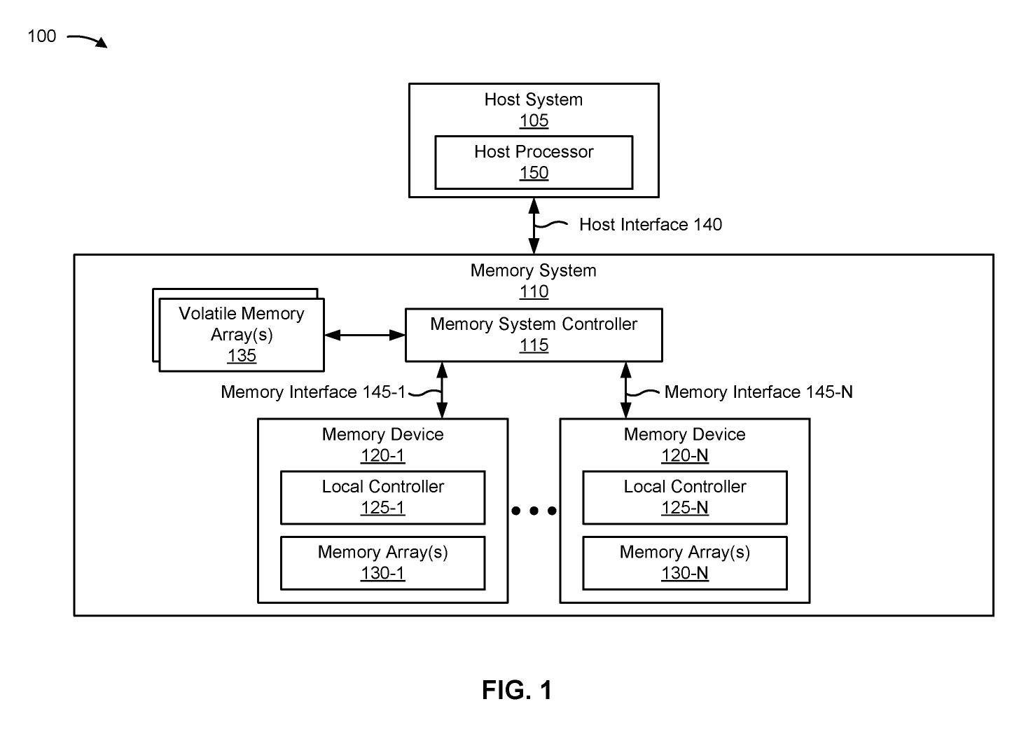

FIG. 1 is a diagram illustrating an example system 100 capable of storing data to host system memory upon entry of a memory system non-operational power state. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, an SSD, a flash memory system (e.g., a NAND flash memory system or a NOR flash memory system), a universal serial bus (USB) drive, a memory card (e.g., a secure digital (SD) card), a secondary storage device, an NVMe device, an embedded multimedia card (eMMC) device, a dual in-line memory module (DIMM), a compute express link (CXL) memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, a CXL controller connected to DRAM, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a PCIe interface, an NVMe interface, a USB interface, a Universal Flash Storage (UFS) interface, an eMMC interface, a double data rate (DDR) interface, a DIMM interface, and/or a CXL interface (e.g., a PCIe/CXL interface).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to allocate a portion of a host system volatile memory as a buffer for storing data associated with the memory system when the memory system is in a non-operational power state; determine a set of data stored in a memory system volatile memory that is to be preserved when the memory system is in the non-operational power state; and write the set of data to the buffer prior to entering the non-operational power state.

In some implementations, one or more systems, devices, apparatuses, components, and/or controllers of FIG. 1 may be configured to store context data of the memory system in a buffer located in a host system volatile memory during entry of the memory system into a non-operational power state, wherein the context data includes state information to be used for resumption of memory system operations without reinitialization of the memory system; and retrieve the context data from the buffer upon exiting the non-operational power state.

In some implementations, one or more systems, devices, apparatuses, components, and/or controllers of FIG. 1 may be configured to allocate a portion of a host system volatile memory as a host allocated drive state memory (HADSM) buffer for storing context data associated with an SSD when the SSD is in a non-operational power state; determine a set of context data stored in an SSD volatile memory that is to be preserved when the SSD is in the non-operational power state; and write the set of data to the HADSM buffer prior to entering the non-operational power state.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

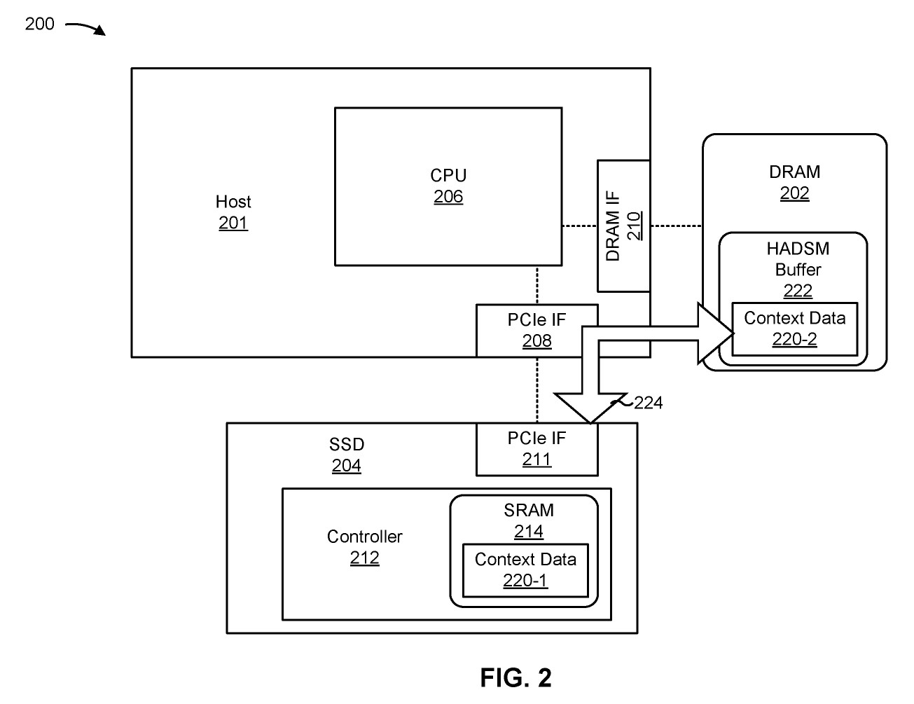

FIG. 2 is a diagram of another example system 200 capable of storing data to host system memory upon entry of a memory system non-operational power state. The system 200 may correspond to system 100 and/or one or more components of the system 100, such as the memory system 110 and/or one or more components of the memory system 110 (e.g., the memory system controller 115, one or more memory devices 120, and/or one or more local controllers 125), the host system 105 and/or one or more components of the host system 105 (e.g., the host processor 150), and/or the host interface 140.

As shown in FIG. 2, the system 200 may include a host 201 (which may correspond to the host system 105) including a DRAM 202 or similar volatile memory connected thereto, and an SSD 204 (which may correspond to the memory system 110). The host 201 may include one or more interface (IF) components configured to operatively connect to, and/or to be used to communicate with, the other components of the system 200, such as the DRAM 202 and/or the SSD 204. For example, the host 201 may include a PCIe IF component 208, which may be configured to connect to and/or communicate with the SSD 204 via a corresponding PCIe interface (e.g., host interface 140), and/or a DRAM IF component 210, which may be configured to connect to and/or communicate with the DRAM 202 via a corresponding memory interface. The SSD 204 may include a corresponding PCIe IF component 211, which may be configured to connect to and/or communicate with the host 201 via the PCIe interface, as well as a controller 212 (which may correspond to the memory system controller 115). In some implementations, the controller 212 may be associated with volatile memory (e.g., volatile memory arrays 135), such as an SRAM 214 or a similar volatile memory.

In some implementations, the SSD 204 may utilize the SRAM 214 for storing certain frequently accessed data associated with the SSD 204, such as context data 220 or similar data. “Context data,” or more simply a memory system’s “context,” refers to the state information or metadata that may be needed for the SSD 204 to resume operations correctly after transitioning from a low-power or non-operational power state back to an active state. In some implementations, context data may include state information (e.g., information associated with internal states of various subsystems within the SSD 204, such as the state of the memory controller, the status of ongoing operations, and/or configuration settings), metadata (e.g., information related to data management within the SSD 204, such as wear-leveling data, mapping tables for logical-to-physical (L2P) address translation, and/or garbage collection status), cache data (e.g., contents of volatile memory caches that store data temporarily before it is written to non-volatile memory), error correction information (e.g., data related to error-correcting codes (ECC) and/or any pending corrections that may need to be applied), and/or pending commands (e.g., information about commands that were in progress or queued at the time the SSD 204 entered the non-operational power state), among other information.

In such implementations, the preservation of the context data 220 may be needed to ensure that the SSD 204, upon transitioning from the non-operational power state back to an operational power state, can quickly and correctly resume operations without the need for extensive reinitialization, which would otherwise degrade performance and potentially lead to data loss or corruption. In that regard, in some implementations the system 200 may be capable of flushing the context data 220 to the DRAM 202 prior to entering the non-operational power state and/or retrieving the context data 220 from the DRAM 202 upon exiting the non-operational power state. For example, the DRAM 202 may be associated with a HADSM buffer 222 or similar buffer that is configured to store context data while the SSD 204 is in the non-operational power state. In some implementations, the HADSM buffer 222 may be a buffer that utilizes the memory read/write support with peer-to-peer (P2P) communication (e.g., between the SSD 204 and the DRAM 202). For example, the system 200 may be capable of utilizing the PCIe standard to exchange context data 220 between the host 201 memory (e.g., DRAM 202) and the SSD 204. More particularly, as indicated by the double-sided arrow labeled with reference number 224, the system 200 may be capable of transmitting the context data 220 between the SSD 204 and the DRAM 202 (e.g., the HADSM buffer 222 of the DRAM 202) via the PCIe IF components 208, 211 and/or the DRAM IF component 210, such as in response to switching between power states, among other examples. In this regard, the SSD 204 may be capable of leveraging a capability of the SSD 204 to access host memory by using memory read and memory write support from PCIe, among other examples.

For example, when the SSD 204 is in the operational power state, a first instance of the context data 220-1 may be stored in the SRAM 214, and, when the SSD 204 is in the non-operational power state, a second instance of the context data 220-2 may be stored in the HADSM buffer 222. Because during the non-operational power state (e.g., PS3 or PS4) the host 201 may remain in an operational power state (such as an operational power state sometimes referred to herein as an “S0” power state, which is an active state at the system level, or a similar power state), power may be maintained at the DRAM 202 notwithstanding that the SSD 204 is in the non-operational power state (e.g., notwithstanding that the SSD 204 has turned off some circuitry to conserve energy). Accordingly, the second instance of the context data 220-2 may be maintained (e.g., periodically refreshed by the host 201 and/or a DRAM controller, among other examples) while the SSD 204 is in the non-operational power state. This may enable the system to forgo flushing some or all context data to nonvolatile memory (e.g., NAND, not shown in FIG. 2 but which may correspond to the memory arrays 130 shown in FIG. 1) from volatile memory (e.g., SRAM 214) when transitioning to the non-operational power state, thereby reducing wear at the nonvolatile memory components and thus increasing a useful life of the SSD 204.

Put another way, during the entry to non-operational power state (e.g., PS3 or PS4), instead of saving the context of the SSD 204 to the NAND or similar nonvolatile memory, the system 200 may write (e.g., using a memory write operation) the context to the DRAM 202, such as into the HADSM buffer 222 or similar allocated memory location. In some implementations, once initialized by the host 201, the HADSM buffer 222 may only be accessed by the SSD 204 (e.g., once initialized by the host 201, the HADSM buffer 222 may no longer be accessed by the host 201). In some implementations, to safeguard against certain security threats (e.g., a man-in-the-middle attack, among other examples), the SSD 204 may encrypt the context data before performing a memory write to the DRAM 202 (e.g., the HADSM buffer 222 of the DRAM 202), such as for a purpose of ensuring context data 220 is protected from mis-use by other applications.

Additionally, or alternatively, when the SSD 204 exits from the non-operational power state (e.g., PS3 and PS4), the SSD 204 may read (e.g., using a memory read operation) back the context data 220 from the DRAM 202 (e.g., the HADSM buffer 222) and may decrypt the context data 220 before loading the context data 220 back into the SRAM 214. In some implementations, any failure or issues detected during the decryption process may result in an error, which may lead to reinitialization of the SSD 204, among other examples.

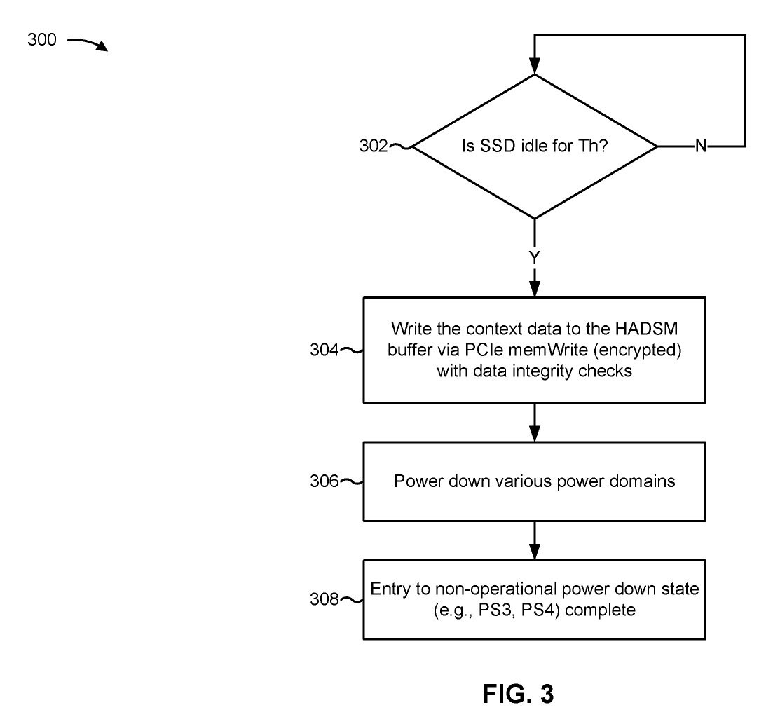

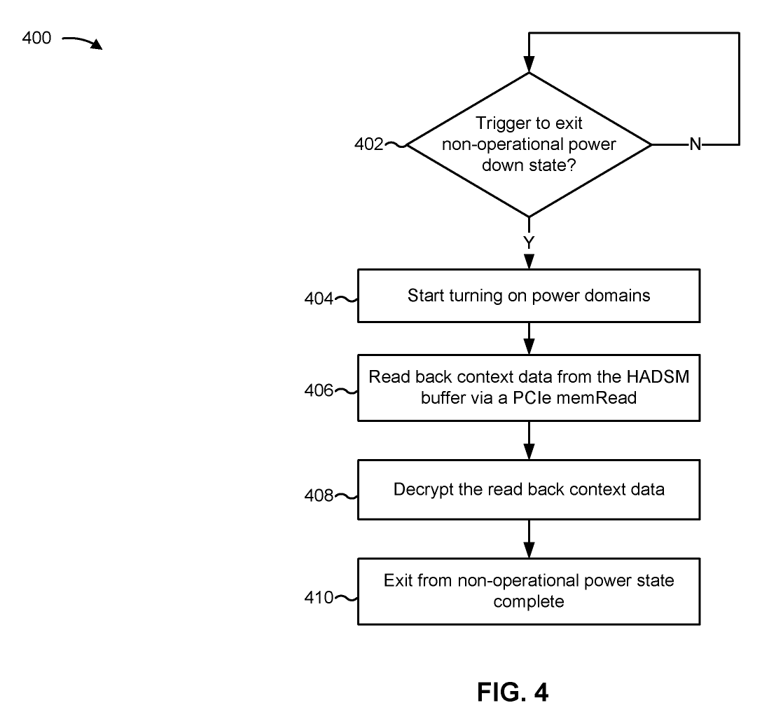

In some implementations, the system 200 may be capable of implementing an approach in which, prior to the SSD 204 entering the non-operational power state, certain portions of the context data 220 are saved to nonvolatile memory (e.g., NAND) associated with the SSD 204, with the remaining portions of the context data 220 being saved to the HADSM buffer 222 (which is sometimes referred to herein as a hybrid approach). Additionally, or alternatively, in some implementations the SSD 204 may store certain portions of the context data 220 (e.g., queue settings, feature settings (e.g., volatile write cache), and/or similar settings) in the DRAM 202 (e.g., the HADSM buffer 222 of the DRAM 202) even when the SSD 204 is in the operational power state. For example, the SSD 204 may save certain portions of the context data in the HADSM buffer 222 immediately after initialization of the SSD 204, such as for a purpose of reducing data transfer that is to be later completed during a non-operational power state transition procedure. Additional aspects regarding writing context data 220 to the HADSM buffer 222 upon entry to a non-operational power state and/or reading context data 220 from the HADSM buffer 222 upon exit from the non-operational power state are described below in connection with FIGS. 3 and 4.

As indicated above, FIG. 2 is provided as an example. Other examples may differ from what is described with regard to FIG. 2.

FIG. 3 is a diagram of an example process 300 associated with a memory system entering a non-operational power state. The operations described in connection with FIG. 3 may be performed by the memory system 110 and/or one or more components of the memory system 110, such as the memory system controller 115, one or more memory devices 120, and/or one or more local controllers 125, and/or the SSD 204 and/or one or more components of the SSD 204, such as the controller 212 and/or the PCIe IF component 211.

In some implementations, a memory system (e.g., SSD 204) may be configured to enter a non-operational power state (e.g., PS3 or PS4, among other examples) when the memory system has been idle for a certain period of time. For example, the memory system may be configured to enter the non-operational power state when the memory system receives no commands from a host system (e.g., host 201) for a certain period of time, such as 750 milliseconds (ms) (e.g., when the SSD 204 is associated with a Linux kernel version 5.x operating system (OS), among other examples), 100 ms (e.g., when the SSD 204 is associated with a Linux kernel version 6.x OS, among other examples), or a similar period of time. Accordingly, as indicated by reference number 302, the memory system may detect whether an idle time of the memory system satisfies a threshold (shown in FIG. 3 as “Th”). If the idle time of the memory system does not satisfy the threshold, the memory system may wait before proceeding, as indicated by the arrow labeled “N” in connection with the operations indicated by reference number 302. However, once the idle time of the memory system satisfies the threshold, the memory system may proceed with transitioning to a non-operational power state, as indicated by the arrow labeled “Y” in connection with the operations indicated by reference number 302.

More particularly, in response to detecting that the idle time of the memory system satisfies the threshold, the memory system may write context data (e.g., context data 220) associated with the memory system to a buffer located at host memory (e.g., HADSM buffer 222), as indicated by reference number 304. For example, as described above in connection with FIG. 2, in some implementations the memory system may allocate a portion of a host system volatile memory (e.g., DRAM 202) as a buffer (e.g., HADSM buffer 222) for storing data associated with the memory system (e.g., context data 220) when the memory system is in a non-operational power state. Accordingly, when the idle time satisfies the threshold and/or when some other condition is satisfied, the memory system may identify a set of data (e.g., context data 220) currently being stored in volatile memory (e.g., SRAM 214) that is to be preserved when the memory system is in the non-operational power state, and/or the memory system may write that set of data to the buffer (e.g., HADSM buffer 222) prior to entering the non-operational power state.

In some implementations, the memory system may write the set of data to the buffer using a PCIe memory write operation (shown in FIG. 3 as “PCIe memWrite”). In that regard, the memory system may use a PCIe interface component (e.g., PCIe IF component 211) to write the set of data to the buffer. Additionally, or alternatively, the memory system may encrypt the set of data prior to writing the set of data to the buffer, such as for a purpose of safeguarding against a man-in-the-middle attack, among other examples. Moreover, the memory system may perform one or more data integrity checks when writing the set of data to the buffer. That is, the memory system may employ one or more mechanisms to ensure the accuracy and consistency of the set of data being written to the buffer to ensure that the set of data is sufficiently stored in the buffer and/or that the set of data can be later retrieved from the buffer accurately and without corruption. In some implementations, the one more data integrity checks may include implementing an ECC (e.g., using an ECC algorithm to generate redundant bits based on the data’s content which are stored along with the actual data and/or which may be used to later check for errors and/or correct errors), implementing a cyclic redundancy check (CRC) (e.g., calculating a CRC value based on the data’s content and storing the CRC value with the data, which may be later recalculated and compared with the stored CRC value to determine if there is a mismatch and thus data corruption), implementing a checksum (e.g., calculating a checksum value based on the data’s content and storing the checksum value with the data, which may be later recalculated and compared with the stored checksum value to determine if there is a mismatch and thus data corruption), implementing a write-verification procedure (e.g., reading back the data immediately after it is written to verify that the correct data was stored), implementing a metadata integrity check (e.g., storing metadata with the set of data that may be later checked to ensure that the metadata is consistent and uncorrupted), implementing a data-mirroring procedure (e.g., storing multiple copies of the data in the buffer), implementing a dual-parity procedure (e.g., storing two parity bits for error correction, such as for a purpose of enabling the memory system to recover data even if two bits are corrupted), and/or implementing a similar data integrity check.

As indicated by reference number 306, after the set of data (e.g., the context data 220) has been successfully written to the buffer (e.g., the HADSM buffer 222), the memory system may begin powering down various power domains (e.g., distinct sections or blocks within the memory system that can be independently powered on or off). For example, in implementations in which the memory system is an SSD (e.g., SSD 204), the non-operational power state may be one of a PS3 or PS4 as defined by an NVMe specification for SSDs. In such implementations, the memory system may power down various power domains as specified by the NVMe specification, among other examples. As indicated by reference number 308, once powering down the various power domains is finished, entry to the non-operational power state (e.g., PS3 or PS4) is complete.

As indicated above, FIG. 3 is provided as an example. Other examples may differ from what is described with regard to FIG. 3.

FIG. 4 is a diagram of an example process 400 associated with a memory system exiting a non-operational power state. The operations described in connection with FIG. 4 may be performed by the memory system 110 and/or one or more components of the memory system 110, such as the memory system controller 115, one or more memory devices 120, and/or one or more local controllers 125, and/or the SSD 204 and/or one or more components of the SSD 204, such as the controller 212 and/or the PCIe IF component 211.

In some implementations, a memory system (e.g., SSD 204) that is operating in a non-operational power state (e.g., PS3 or P24) may receive a trigger to exit the non-operational power state. As used herein, a trigger may refer to an action that indicates to the memory system that the memory system should return to an operational power state to perform read or write operations and/or to respond to commands from the host system (e.g., host 201). In that regard, the trigger may include one or more of reception of a host system command (e.g., read/write requests, administrative commands, and/or similar commands), detection of interface activity (e.g., activity on the PCIe interface, such as link negotiation or reestablishment), determination that periodic maintenance is to be performed (e.g., garbage collection, wear leveling, or the like), reception of an interrupt and/or alert, and/or a similar trigger. In such implementations, the memory system may determine whether a trigger to exit the non-operational power state has been received and/or detected, as indicated by reference number 402. If the trigger has not been received or detected, as indicated by the arrow labeled “N” in connection with the operations shown by reference number 402, the memory system may wait before proceeding (e.g., the memory system may remain in the non-operational power state). However, once the trigger has been received or detected, as indicated by the arrow labeled “Y” in connection with the operations shown by reference number 402, the memory system may proceed with exiting from the non-operational power state.

More particularly, as indicated by reference number 404, the memory system may begin by turning on the various power domains that were powered off, as described above in connection with reference number 306. For example, the memory system may power on the distinct sections or blocks within the memory system that were independently powered off as part of entering the non-operational power state (e.g., PS3 or PS4). Moreover, as indicated by reference number 406, the memory system may read the set of data (e.g., context data 220) from the buffer (e.g., HADSM buffer 222). In some implementations, reading the set of data from the buffer may include reading the set of data using a PCIe memory read operation (shown in FIG. 4 as “PCIe memRead). In that regard, reading the set of data from the buffer may be performed using a PCIe interface component associated with the memory system (e.g., PCIe IF component 211).

As described above in connection with reference number 304, in some implementations the memory system may encrypt the set of data written to the buffer, such as for a purpose of safeguarding against a man-in-the-middle attack or similar security threat. In such implementations, as indicated by reference number 408, the memory system may decrypt the set of data after reading the set of data from the buffer. Once decrypted, the memory system may store the set of data locally, such as by writing the set of data to the memory system volatile memory (e.g., SRAM 214). As indicated by reference number 410, once the set of data (e.g., context data 220) has been successfully retrieved from the buffer (e.g., HADSM buffer 222) and/or written to local memory (e.g., SRAM 214), the exit from the non-operational power state is complete. On the other hand, if the set of data is not successfully retrieved, decrypted, and/or written to local memory, the memory system may take another action, such as triggering a reinitialization of the memory system to reestablish context data, among other examples. Put another way, in some implementations the memory system may detect an error during retrieval of the set of data, decrypting of the set of data, and/or writing of the set of data to local memory, and thus the memory system may trigger a reinitialization of the memory system based on detecting the error.

As indicated above, FIG. 4 is provided as an example. Other examples may differ from what is described with regard to FIG. 4.

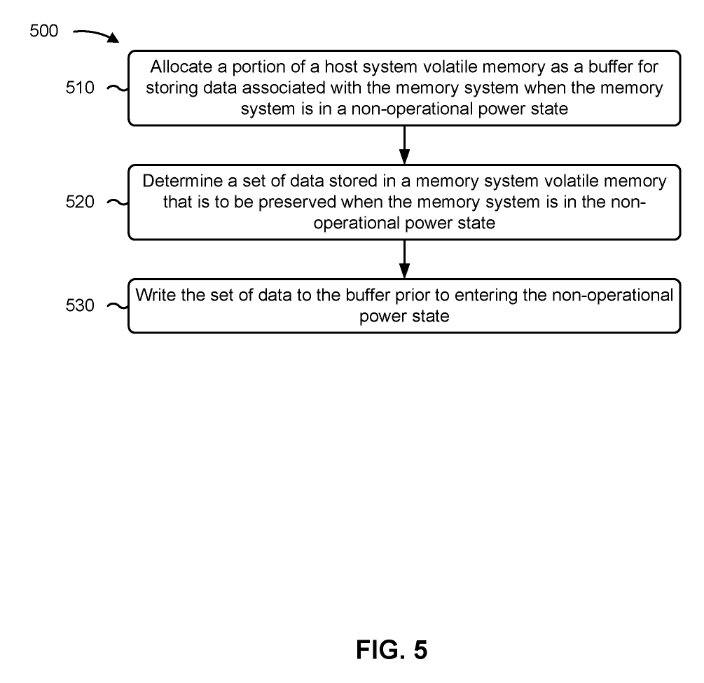

FIG. 5 is a flowchart of an example method 500 associated with storing data to host system memory upon entry of a memory system non-operational power state. In some implementations, a memory system (e.g., the memory system 110 and/or SSD 204) may perform or may be configured to perform the method 500. In some implementations, another device or a group of devices separate from or including the memory system (e.g., host system 105 and/or host 201) may perform or may be configured to perform the method 500. Additionally, or alternatively, one or more components of the memory system (e.g., memory system controller 115, local controller 125, controller 212, and/or PCIe IF component 211) may perform or may be configured to perform the method 500. Thus, means for performing the method 500 may include the memory system and/or one or more components of the memory system. Additionally, or alternatively, a non-transitory computer-readable medium may store one or more instructions that, when executed by the memory system, cause the memory system to perform the method 500.

As shown in FIG. 5, the method 500 may include allocating a portion of a host system volatile memory as a buffer for storing data associated with the memory system when the memory system is in a non-operational power state (block 510). For example, as described above in connection with FIGS. 2 and 3, the SSD 204 may allocate a portion of the host 201 DRAM 202 as the HADSM buffer 222 for storing the context data 220 when the SSD 204 is in a non-operational power state (e.g., PS3 or PS4, among other examples).

As further shown in FIG. 5, the method 500 may include determining a set of data stored in a memory system volatile memory that is to be preserved when the memory system is in the non-operational power state (block 520). For example, as described above in connection with FIGS. 2 and 3, the SSD 204 may identify context data 220 that is to be stored in the HADSM buffer 222 when the SSD 204 is in the non-operational power state,

As further shown in FIG. 5, the method 500 may include writing the set of data to the buffer prior to entering the non-operational power state (block 530). For example, as described above in connection with FIGS. 2 and 3, the SSD 204 may write the context data 220 to the HADSM buffer 222 prior to entering the non-operational power state.

The method 500 may include additional aspects, such as any single aspect or any combination of aspects described below and/or described in connection with one or more other methods or operations described elsewhere herein.

In a first aspect, writing the set of data to the buffer includes writing the set of data using a PCIe memory write operation. For example, as described above in connection with FIGS. 2 and 3, the SSD 204 may write the context data 220 to the HADSM buffer 222 using a PCIe memWrite operation.

In a second aspect, alone or in combination with the first aspect, writing the set of data to the buffer is performed using a PCIe interface component associated with the memory system. For example, as described above in connection with FIGS. 2 and 3, the SSD 204 may write the context data 220 to the HADSM buffer 222 using the PCIe IF component 211.

In a third aspect, alone or in combination with one or more of the first and second aspects, the method 500 includes encrypting, by the memory system, the set of data prior to writing the set of data to the buffer. For example, as described above in connection with reference number 304, the SSD 204 may encrypt the context data 220 prior to writing the context data 220 to the HADSM buffer 222, such as for a purpose of safeguarding against a man-in-the-middle attack or a similar security threat.

In a fourth aspect, alone or in combination with one or more of the first through third aspects, the method 500 includes reading, by the memory system, the set of data from the buffer after exiting the non-operational power state. For example, as described above in connection with FIGS. 2 and 4, the SSD 204 may read the context data 220 from the HADSM buffer 222 upon exiting the non-operational power state.

In a fifth aspect, alone or in combination with one or more of the first through fourth aspects, reading the set of data from the buffer includes reading the set of data using a PCIe memory read operation. For example, as described above in connection with FIGS. 2 and 4, the SSD 204 may read the context data 220 from the HADSM buffer 222 using a PCIe memRead operation.

In a sixth aspect, alone or in combination with one or more of the first through fifth aspects, reading the set of data from the buffer is performed using a PCIe interface component associated with the memory system. For example, as described above in connection with FIGS. 2 and 4, the SSD 204 may read the context data 220 from the HADSM buffer 222 using the PCIe IF component 211.

In a seventh aspect, alone or in combination with one or more of the first through sixth aspects, the set of data is encrypted prior to writing the set of data to the buffer, and wherein the method further comprises decrypting, by the memory system, the set of data after reading the set of data from the buffer. For example, as described above in connection with reference number 408, in implementations in which the context data 220 is encrypted prior to being written to the HADSM buffer 222, the SSD 204 may decrypt the context data 220 after reading the context data 220 back from the HADSM buffer 222.

In an eighth aspect, alone or in combination with one or more of the first through seventh aspects, the method 500 includes writing, by the memory system, the set of data to the memory system volatile memory after decrypting the set of data. For example, as described above in connection with FIGS. 2 and 4, the SSD 204 may write the context data 220 locally to SRAM 214 after decrypting the context data 220.

In a ninth aspect, alone or in combination with one or more of the first through eighth aspects, the method 500 includes detecting, by the memory system, an error during decrypting the set of data, and triggering, by the memory system, reinitialization of the memory system based on detecting the error. For example, as described above in connection with FIGS. 2 and 4, when an error is detected during reading the context data 220 back from the HADSM buffer 222, during decryption of the context data 220, and/or during writing the context data 220 locally to the SRAM 214, the SSD 204 may trigger a reinitialization of the SSD 204.

In a tenth aspect, alone or in combination with one or more of the first through ninth aspects, the memory system is associated with an SSD, and the non-operational power state is associated with one of a power state 3 associated with an NVMe specification for SSDs or a power state 4 associated with the NVMe specification for SSDs. For example, as described above in connection with FIGS. 2 and 3, the SSD 204 may enter one of a PS3 or PS4 as the non-operational power state.

In an eleventh aspect, alone or in combination with one or more of the first through tenth aspects, the method 500 includes performing, by the memory system, one or more data integrity checks for the set of data during writing the set of data to the buffer. For example, as described above in connection with reference number 304, the SSD 204 may, when writing the context data 220 to the HADSM buffer 222, implement one or more of an ECC, a CRC, a checksum, a write-verification procedure, a metadata integrity check, a data-mirroring procedure, a dual-parity procedure, and/or a similar data integrity check.

In a twelfth aspect, alone or in combination with one or more of the first through eleventh aspects, the method 500 includes detecting, by the memory system, that an idle time of the memory system satisfies a threshold, wherein writing the set of data to the buffer is performed in response to detecting that the idle time of the memory system satisfies the threshold. For example, as described above in connection with reference number 302, the SSD 204 may initiate the power-down procedure and/or write the context data 220 to the HADSM buffer 222 in response to determining that the SSD 204 has been idle for 750 ms, 100 ms, or a similar idle threshold.

In a thirteenth aspect, alone or in combination with one or more of the first through twelfth aspects, the method 500 includes determining, by the memory system, another set of data that is to be stored in the buffer when the memory system is in both the non-operational power state and an operational power state and writing the other set of data to the buffer. For example, as described above in connection with FIG. 2, the SSD 204 may store certain portions of the context data 220 (e.g., queue settings, feature settings (e.g., volatile write cache), and/or similar settings) in the HADSM buffer 222 even when in the operational power state.

In a fourteenth aspect, alone or in combination with one or more of the first through thirteenth aspects, the method 500 includes determining, by the memory system, another set of data that is to be stored in a memory system non-volatile memory when the memory system is in the non-operational power state, and writing, by the memory system, the other set of data to the memory system non-volatile memory prior to entering the non-operational power state. For example, as described above in connection with FIG. 2, the SSD 204 may implement a hybrid approach in which, prior to the SSD 204 entering the non-operational power state, certain portions of the context data 220 is saved to nonvolatile memory (e.g., NAND) associated with the SSD 204, with the remaining portions of the context data 220 being saved to the HADSM buffer 222.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a method includes allocating, by a memory system, a portion of a host system volatile memory as a buffer for storing data associated with the memory system when the memory system is in a non-operational power state; determining, by the memory system, a set of data stored in a memory system volatile memory that is to be preserved when the memory system is in the non-operational power state; and writing, by the memory system, the set of data to the buffer prior to entering the non-operational power state.

In some implementations, a memory system includes one or more components configured to: store context data of the memory system in a buffer located in a host system volatile memory during entry of the memory system into a non-operational power state, wherein the context data includes state information to be used for resumption of memory system operations without reinitialization of the memory system; and retrieve the context data from the buffer upon exiting the non-operational power state.

In some implementations, an SSD includes one or more components configured to: allocate a portion of a host system volatile memory as an HADSM buffer for storing context data associated with the SSD when the SSD is in a non-operational power state; determine a set of context data stored in an SSD volatile memory that is to be preserved when the SSD is in the non-operational power state; and write the set of data to the HADSM buffer prior to entering the non-operational power state.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
allocating, by a memory system, a portion of a host system volatile memory as a buffer for storing data associated with the memory system when the memory system is in a non-operational power state;
determining, by the memory system, a set of data stored in a memory system volatile memory that is to be preserved when the memory system is in the non-operational power state; and
writing, by the memory system, the set of data to the buffer prior to entering the non-operational power state.

2. The method of claim 1, wherein writing the set of data to the buffer includes writing the set of data using a peripheral component interconnect express (PCIe) memory write operation.

3. The method of claim 2, wherein writing the set of data to the buffer is performed using a PCIe interface component associated with the memory system.

4. The method of claim 1, further comprising encrypting, by the memory system, the set of data prior to writing the set of data to the buffer.

5. The method of claim 1, further comprising:
reading, by the memory system, the set of data from the buffer after exiting the non-operational power state.

6. The method of claim 5, wherein reading the set of data from the buffer includes reading the set of data using a peripheral component interconnect express (PCIe) memory read operation.

7. The method of claim 6, wherein reading the set of data from the buffer is performed using a PCIe interface component associated with the memory system.

8. The method of claim 5, wherein the set of data is encrypted prior to writing the set of data to the buffer, and
wherein the method further comprises decrypting, by the memory system, the set of data after reading the set of data from the buffer.

9. The method of claim 8, further comprising writing, by the memory system, the set of data to the memory system volatile memory after decrypting the set of data.

10. The method of claim 8, further comprising:
detecting, by the memory system, an error during decrypting the set of data; and
triggering, by the memory system, reinitialization of the memory system based on detecting the error.

11. The method of claim 1, wherein the memory system is associated with a solid-state drive (SSD), and
wherein the non-operational power state is associated with one of a power state 3 associated with a non-volatile memory express (NVMe) specification for SSDs or a power state 4 associated with the NVMe specification for SSDs.

12. The method of claim 1, further comprising performing, by the memory system, one or more data integrity checks for the set of data during writing the set of data to the buffer.

13. The method of claim 1, further comprising detecting, by the memory system, that an idle time of the memory system satisfies a threshold,
wherein writing the set of data to the buffer is performed in response to detecting that the idle time of the memory system satisfies the threshold.

14. The method of claim 1, further comprising:
determining, by the memory system, another set of data that is to be stored in the buffer when the memory system is in both the non-operational power state and an operational power state: and
writing, by the memory system, the other set of data to the buffer.

15. The method of claim 1, further comprising:
determining, by the memory system, another set of data that is to be stored in a memory system non-volatile memory when the memory system is in the non-operational power state; and
writing, by the memory system, the other set of data to the memory system non-volatile memory prior to entering the non-operational power state.

16. A memory system, comprising:
one or more components configured to:
store context data of the memory system in a buffer located in a host system volatile memory during entry of the memory system into a non-operational power state,
wherein the context data includes state information to be used for resumption of memory system operations without reinitialization of the memory system; and
retrieve the context data from the buffer upon exiting the non-operational power state.

17. The memory system of claim 16, wherein the one or more components are further configured to:
encrypt the context data prior to storing the context data in the buffer; and
decrypt the context data after retrieving the context data from the buffer.

18. The memory system of claim 16, wherein the non-operational power state is one of a power state 3 associated with a non-volatile memory express (NVMe) specification for solid-state drives (SSDs) or a power state 4 associated with the NVMe specification for SSDs.

19. The memory system of claim 16, wherein the one or more components are further configured to access the buffer using peripheral component interconnect express memory read and write commands.

20. The memory system of claim 16, wherein the one or more components, to store the context data in the buffer, are further configured to generate data integrity checks for the context data prior to storage in the buffer.

21. The memory system of claim 16, wherein the one or more components are further configured to:
detect an error during retrieval of the context data from the buffer; and
initiate a reinitialization of the memory system based on detecting the error.

22. A solid-state drive (SSD), comprising:
one or more components configured to:
allocate a portion of a host system volatile memory as a host allocated drive state memory (HADSM) buffer for storing context data associated with the SSD when the SSD is in a non-operational power state;
determine a set of context data stored in an SSD volatile memory that is to be preserved when the SSD is in the non-operational power state; and
write the set of data to the HADSM buffer prior to entering the non-operational power state.

23. The SSD of claim 22, wherein the one or more components, to write the set of context data to the HADSM buffer, are configured to write the set of context data to the HADSM buffer using a peripheral component interconnect express interface component of the SSD.

24. The SSD of claim 22, wherein the one or more components are further configured to encrypt the set of context data prior to writing the set of context data to the HADSM buffer.

25. The SSD of claim 22, wherein the one or more components are further configured to:
read the set of context data from the HADSM buffer after exiting the non-operational power state; and
write the set of context data to the SSD volatile memory.
